(19) United States
(12) Patent Application Publication
(10) Pub. No.: US 2003/0154069 A1
(43) Pub. Date: Aug. 14, 2003

(54) Computerized system and method for converting selected text between languages

(75) Inventors: David Carew, (US); Hung Dinh, Round Rock, TX (US); Teng Hu, Austin, TX (US); Mansoor Lakhdhir, Austin, TX (US); Angela Eng-Ling Noether, Austin, TX (US)

Correspondence Address: HOFFMAN WARNICK & D'ALESSANDRO, LLC, 3 E-COMM SQUARE, ALBANY, NY, 12207

(73) Assignee: INTERNATIONAL BUSINESS MACHINES CORPORATION, ARMONK, NY

(21) Appl. No.: 10/076,326

(22) Filed: Feb. 14, 2002

(51) Int. Cl. G06F 17/28

(52) U.S. Cl. 704/7

(57) ABSTRACT

The present invention provides a web-based/computerized system and method for converting selected text between languages. Specifically, under the present invention, a user can designate a source language and a destination language using a computerized device (e.g., personal computer, handheld device, etc.). Once designated, an updatable language dictionary corresponding to the designated languages will be accessed (e.g., downloaded or referenced) at a remote source and used to convert selected text between the languages.

### BACKGROUND OF THE INVENTION

1. Field of the Invention

The present invention generally relates to a computerized system and method for converting selected text between languages. Specifically, under the present invention, an updatable language dictionary corresponding to two designated languages is accessed and used to convert selected text between the designated languages.

2. Background Art

As international travel increases, the need for travelers to be able to communicate in a foreign language becomes greater. Specifically, each year many people travel to foreign countries for vacation or business. Once in the foreign country, communicating everyday needs is an obstacle as the traveler often finds that he/she is unable to communicate even basic ideas.

Currently technology allows travelers to carry portable language translation devices, which can provide the traveler with translation of words between languages. Such products, however, are typically stand-alone products that provide translation between predetermined languages. As such, the traveler may have to purchase several devices for converting between multiple languages. Moreover, such portable devices provide no mechanism for a user to update the internal language dictionary. As is well known, languages can constantly change. The inability to obtain such updates in a translation device often leaves the traveler with an out of date device.

Other technology allows the traveler to obtain translation software. Typically, such software is purchased in a store or from a world wide web site. In the case of the former, the traveler must manually search for conversion products for desired languages. In the case of the latter, the traveler is forced to manually navigate a web site in search of conversion products for desired languages. Moreover, none of the existing solutions provide a way for the traveler to remotely update the software's language dictionaries. Rather, the traveler must purchase the next version of the software (if available) by manually navigating back to the world wide web site (or back to the retail store) and purchasing the next version.

Still yet, existing technology also fails to provide a traveler with the capability to decide how text can be selected for conversion. Specifically, no existing product allows the traveler to designate a hot-key sequence for selecting a particular word (or group of words) of text for conversion.

In view of the foregoing, there exists a need for a computerized system and method for converting selected text between languages. A further need exists for a system and method wherein a user can designate a source language and a destination language at an interface, and a language dictionary corresponding to the designated languages will be accessed (e.g., retrieved or referenced). A need also exists for a system and method wherein a user can designate a keystroke for selecting text for conversion. A further need exists for a system and method wherein a retrieved language dictionary can be updated. In addition, a need exists for a system and method wherein selected text can be translated and/or pronounced in a designated language.

### SUMMARY OF THE INVENTION

In general, the present invention provides a system and method for converting selected text between languages. Specifically, the present invention allows a user to designate a source language and a destination language. Once designated, a language dictionary at a remote source corresponding to the designated languages will be accessed (e.g., downloaded) and used to convert selected text between the designated source language and destination language. Included in the conversion is translation and/or pronunciation of the selected text. To select particular text, the user can use a previously designated keystroke. The present invention also allows the obtained language dictionary to be updated locally based on a designated update schedule.

According to a first aspect of the present invention, a computerized system for converting selected text between languages is provided. The system comprises: (1) a language system for designating a source language and a destination language; (2) a dictionary system for accessing a language dictionary corresponding to the designated source language and destination language; and (3) a translation system for translating selected text between the source language and the destination language based upon the language dictionary.

According to a second aspect of the present invention, a computerized system for converting selected text between languages is provided. The system comprises: (1) a language system for designating a source language and a destination language; (2) a dictionary system for retrieving a language dictionary corresponding to the designated source language and destination language from a remote source; (3) a key system for designating a keystroke for selecting displayed text; (4) a translation system for translating the selected text from the source language to the destination language based upon the language dictionary; (5) a pronunciation system for pronouncing the selected text in the destination language based upon the language dictionary; and (6) an update system for updating the retrieved language dictionary.

According to a third aspect of the present invention, a computerized method for converting selected text between languages is provided. The method comprises: (1) providing an interface for designating a source language and a destination language; (2) accessing a language dictionary corresponding to the designated source language and destination language; (3) selecting displayed text using a predefined keystroke; and (4) translating the selected text between the source language and the destination language based on the language dictionary.

According to a fourth aspect of the present invention, a program product stored on a recordable medium for converting selected text between languages is provided. When executed the program product, comprises: (1) program code for designating a source language and a destination language; (2) program code for accessing a language dictionary corresponding to the designated source language and destination language; and (3) program code for translating selected text between the source language and the destination language.

Therefore, the present invention provides a system and method for converting text between languages.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a conversion system according to the present invention.

FIG. 2 depicts an interface for designating a source language, a destination language, a text selection keystroke and an update schedule.

FIG. 3 depicts text selected on a display.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAIL DESCRIPTION OF THE INVENTION

In general, the present invention provides a web-based/computerized system and method for converting selected text between languages. Specifically, under the present invention, a user can designate a source language and a destination language using a computerized device (e.g., personal computer, handheld device, etc.). Once designated, an updatable language dictionary corresponding to the designated languages will be accessed (e.g., downloaded or referenced) at a remote source and used to convert selected text between the designated languages. Conversion of the text can include, for example, translation and/or pronunciation of the selected text in a designated language. The user is also provided with other various features as will be further described below. As used herein, the term “source language” is intended to mean a language from which text is converted while the term “destination language” is intended to mean a language into which text is converted.

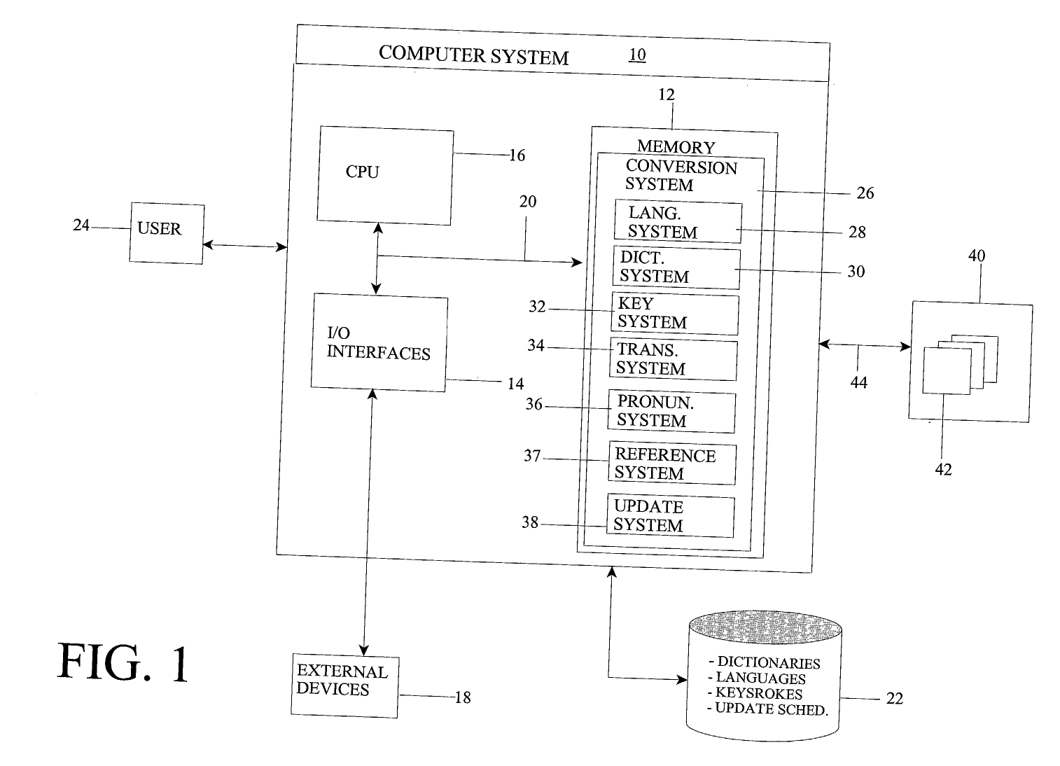

Referring now to FIG. 1, a computer system 10 having a conversion system 26 according to the present invention is shown. User 24 utilizes computer system 10 to obtain language dictionaries 42 from remote source 40. Computer system 10 can be any computerized mechanism capable communicating with source 40 including, for example, a personal computer, a workstation, a personal digital assistant, a pager, a web phone, etc. Moreover, source 40 is typically a computerized system that includes storage for language dictionaries 42. Communication between computer system 10 and source 40 occurs via communications link 44. Communications link 44 can include a direct terminal connection between computer system 10 and source 44, or an indirect connection such as that in a client-server environment. In the case of the latter, the computer system 10 and source 40 may be connected via the Internet, wide area networks (WAN), local area networks (LAN) or other private networks. The computer system 10 and source 40 may utilize conventional token ring connectivity, Ethernet, or other conventional communications standards. Where the computer system 10 is connected to the source 40 via the Internet, connectivity could be provided by conventional TCP/IP sockets-based protocol. In this instance, the computer system 10 would utilize an Internet service provider to establish connectivity to the source 40.

As depicted, computer system 10 generally comprises memory 12, input/output (I/O) interfaces 14, a central processing unit (CPU) 16, external devices/resources 18, bus 20, and database 22. Memory 12 may comprise any known type of data storage and/or transmission media, including magnetic media, optical media, random access memory (RAM), read-only memory (ROM), a data cache, a data object, etc. Moreover, memory 12 may reside at a single physical location, comprising one or more types of data storage, or be distributed across a plurality of physical systems in various forms. CPU 16 may likewise comprise a single processing unit, or be distributed across one or more processing units in one or more locations, e.g., on a client and server.

I/O interfaces 14 may comprise any system for exchanging information from an external source. External devices 18 may comprise any known type of external device, including speakers, a CRT, LED screen, hand-held device (if computer system 10 is a personal computer or the like), keyboard, mouse, voice recognition system, speech output system, printer, monitor, facsimile, pager, etc. It should be understood that the embodiment of computer system 10 shown in FIG. 1 is typically representative of a personal computer or the like, and is shown for clarity purposes only. In the event computer system 10 is a self-contained device such as a personal digital assistant, certain known variations will exist. For example, certain components such as a speaker or a display would be located within computer system 10 and not as external devices as shown.

Bus 20 provides a communication link between each of the components in the computer system 10 and likewise may comprise any known type of transmission link, including electrical, optical, wireless, etc. In addition, although not shown, additional components, such as cache memory, communication systems, system software, etc., may be incorporated into computer system 10.

Database 22 provides storage for information necessary to carry out the present invention. Such information could include, inter alia: (1) retrieved language dictionaries; (2) designated languages; (3) designated keystrokes; and (4) designated update schedules. Database 22 may include one or more storage devices, such as a magnetic disk drive or an optical disk drive. In another embodiment database 22 includes data distributed across, for example, a local area network (LAN), wide area network (WAN) or a storage area network (SAN) (not shown). Database 22 may also be configured in such a way that one of ordinary skill in the art may interpret it to include one or more storage devices. Moreover, it should be understood that database 22 could alternatively exist within computer system 10.

Stored in memory 12 is conversion system 26. As depicted, conversion system 26 includes language system 28, dictionary system 30, key system 32, translation system 34, pronunciation system 36, reference system 37 and update system 38. In general user 24 utilizes conversion system 26 obtain updatable language dictionaries from source 40 to convert text between a designated source language and destination language. Specifically, user 24 designates a source language and a destination language via language system 28. For example, if user 24 wishes to convert text from English to Chinese, the source language would be designated as English, while the destination language would be designated as Chinese.

Designating particular languages prevents user 24 from having to manually search for products corresponding to desired languages. Moreover, it should be understood that since user 24 can designate any quantity of languages via language system 28, any quantity of language dictionaries can be accessed from computer system 10. This prevents user 24 from having to obtain numerous different devices. In existing devices, user 24 has to obtain a separate device for each set of languages. For example user 24 would have to obtain one device for conversion between English and Chinese, and another device for converting between French and Spanish).

Once the desired languages have been designated, dictionary system 30 communicates with source 40 to access an updateable language dictionary 42 that corresponds to the set of designated languages. As shown, source 40 may provide storage for a group of language dictionaries 42, with each language dictionary 42 providing conversion between two languages (e.g., English-Chinese). A particular language dictionary 42 that corresponds to the set of designated languages will be obtained by dictionary system 30. In the event that user 24 designated more than one set of languages (e.g., English-Chinese and French-Spanish), more than one updateable language dictionary 42 will be accessed. As will be further described below, language dictionaries 42 should be sufficiently developed so that both translation and audio pronunciation of the terms therein can be produced. As indicated above, computer system 10 may be directly connected to source 40, or may be indirectly connected to source. In either event, source 40 is considered to be remote from computer system 10. In one embodiment, language dictionary 42 is downloaded to computer system 10 and stored locally (i.e., in database 22). In another embodiment, language dictionary 42 remains at source 40, and is referenced by dictionary system 30 as needed by user 24. In the case of the former, user 24 need not establish a live connection to source 40 whenever language dictionary 42 is needed. However, in the case of the latter, user 24 need not update language dictionary 42, rather, language dictionary 42 will be automatically updated at source 40. In either event, language dictionary 42 is updateable and will be accessed by dictionary system 26 to provide language conversion for selected text.

Key system 32 allows user 24 to designate a text selection keystroke for selecting text for conversion. Specifically, under the present invention, user 24 can select one or more words displayed (e.g., on the computer system display) for conversion between the designated languages. To select a word for conversion, user 24 can designate a text selection keystroke. For example, if computer system 10 is a personal computer, user 24 may designate that a combination of pressing the shift key and the left mouse button will highlight text for conversion.

Alternatively, if computer system 10 is a personal digital assistant, a designated hot keystroke may be tapping the pointer three times on a particular piece of displayed text. The capability to create text selection keystrokes allows user 24 to configure conversion system 26 in a form most convenient and efficient to him/her.

Once particular text has been selected for conversion by user 24, translation system 34 translates the selected text between the designated languages. Specifically, as will be further described below, once text is selected, a tool bar or the like could be presented to user 24. The tool bar can be manipulated by user 24 to perform the various features of the present invention. For example, if user 24 selected a translation icon on the tool bar, translation system 34 would use the accessed language dictionary (locally or at source 40) to translate the selected text from the source language to the destination language.

If computer system 10 is equipped with an audio output such as a speaker (either internal or external), user 24 may also choose to hear the pronunciation of the selected text. This can be accomplished by selecting a pronunciation icon on the displayed tool bar, which will cause pronunciation system 36 to use the accessed language dictionary to pronounce the selected text. In pronouncing the selected text, pronunciation system 36 could pronounce the text either in the destination language, the source language, or in both languages.

On occasion, user 24 may wish to reference text previously selected and converted. Accordingly, any text selected for translation and/or pronunciation could be stored in database 22 and accessed by reference system 37 upon demand by user 24. Specifically, reference system 37 could provides user 24 with a list of the previously converted text. User 24 can then select particular text on the list and review the translation and/or pronunciation thereof. This prevents user 24 from having to convert the same text more than once.

As indicated above, existing systems fail to provide a way for user 24 to update an retrieved (i.e., downloaded) language dictionary 42. In contrast, the products currently available require user 24 to purchase a new version of the entire product. Thus, user 24 may be forced to wait a number of years for an updated language dictionary. The present invention allows any downloaded language dictionary 42 to be updated at any time. In one embodiment, the language dictionary 42 is updated according to predetermined update schedules set in conversion system 26. In another embodiment, update system 38 allows user 24 to designate an update schedule. In either event, when an update time is reached, update system 38 could either remind user 24 (e.g., with an alarm noise or the like) to connect to source 40, or update system 38 could automatically connect to source. In the case of the latter, a live or direct communication link 44 between computer system 10 and source 40 would exist.

Once an update time has been reached, and a connection is made to source 40, it will first be determined whether an update is necessary. Specifically, downloaded language dictionary 42 (i.e., stored in database 22) could be the most recent version available. To ascertain whether this is the case, update system 38 will compare the size of language dictionary 42 stored in database 22 to the corresponding language dictionary stored at source 40. If the sizes are identical, no change has occurred and an update is not necessary. Conversely, if the stored language dictionary 42 has a size that is different from the corresponding language dictionary stored at source 40, an update is necessary and will be automatically retrieved.

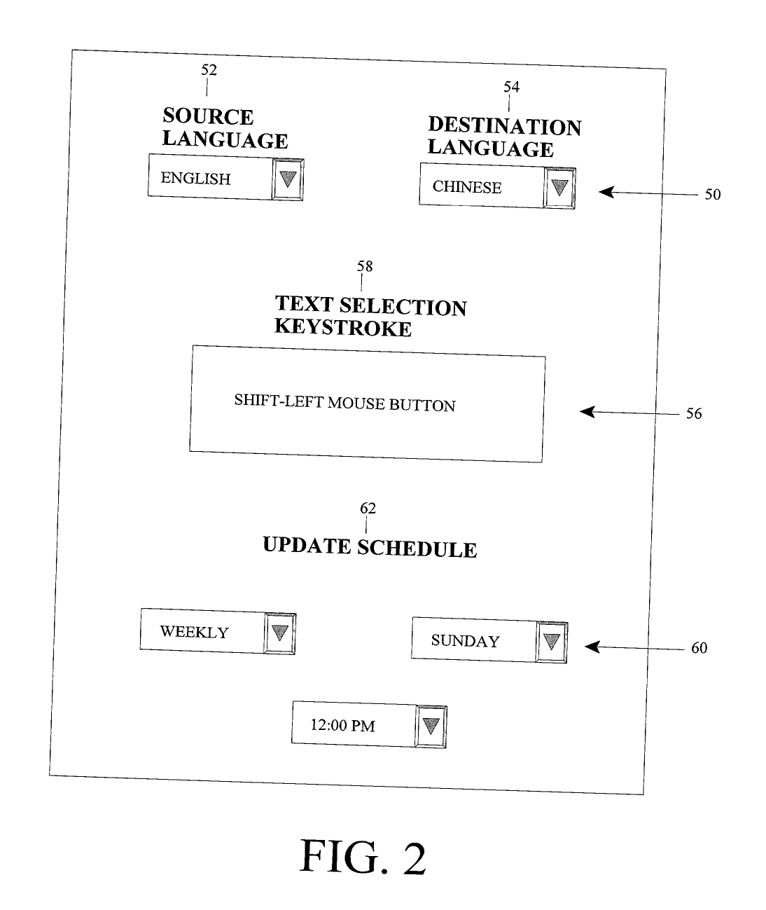

It should be appreciated that the depiction of conversion system 26 shown in FIG. 1 is for illustrative purposes only and other variations exist. For example, language system 26 and dictionary system 28 may exist as a single system. It should also be understood that the systems within conversion system 26 that allow user 24 to designate information (e.g., language system 28, key system 32 and update system 38) include an interface. Such an interface could include any known format for allows user to designate 24 the information discussed herein. Referring now to FIG. 2 exemplary interfaces according to the present invention are shown. As depicted, interface 50 is for designating a source language 52 and a destination language 54. As depicted, the designated source language 52 is English, while the designated destination language 54 is Chinese. This shows that user 24 wishes to convert text between English and Chinese. Interface 52 is for user 26 to designate a text selection keystroke 58, as discussed above. For the example shown in FIG. 2, user 24 has designated the keystroke of “Shift and Left Mouse Button.” Accordingly, whenever user 24 points a mouse device to particular text then presses the shift key and the left mouse button, the text to which the mouse device points will be selected for conversion. Interface 60 is for user 24 to designate a language dictionary update schedule 62. As shown in FIG. 2, user 24 has designated that the downloaded language dictionary 42 will be updated weekly on Sundays at 12:00 PM.

It should be understood that the depiction of interfaces as drop-down menus and a text box are for illustrative purposes only and other equivalent variations exist. For example, interface 50 could alternatively be one or more text boxes.

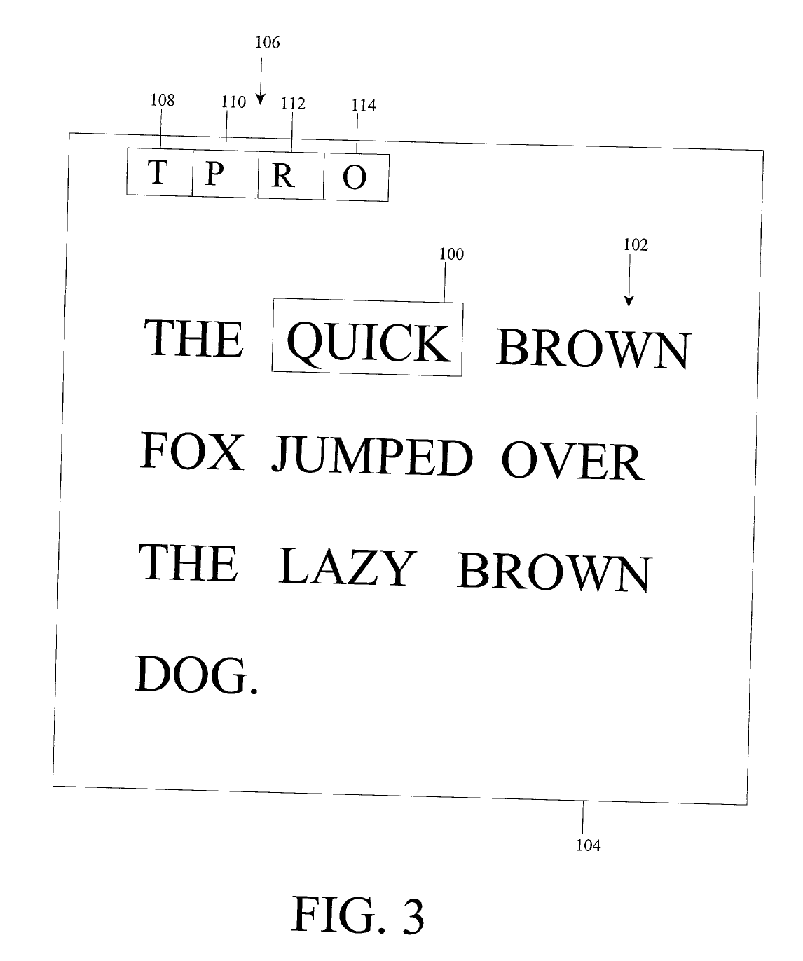

Referring now to FIG. 3, a exemplary view of selected text 100 on a display 104 is depicted. It should be understood that display 104 is intended to be a display for computer system 10. As such, display 104 could be an external computer monitor, or an internal LED display for a handheld device. Portions of text 102 displayed on display 104 can be selected by user 24 for conversion between a designated source language and a designated destination language. The example shown in FIG. 3 assumes that user 24 has designated English as the source language and Chinese as the destination language.

As indicated above, user 24 can designate a text selection keystroke for selecting text 100. For example, if user 24 wishes to convert the term “Quick,” user 24 would perform the text selection keystroke in conjunction with “Quick.” Once the term is selected, conversion toolbar 106 is displayed. Included with tool bar are translation icon 108, pronunciation icon 110 and reference icon 112. Other icons 114 corresponding to other features could also be provided, as will be further described below. If user wished to translate selected text 100 to Chinese, user 24 would select translation icon 108. This would cause translation system 34 to access the corresponding language dictionary to determine and display the Chinese translation for the term “Quick.” If user 24 wished to hear selected text 100 pronounced in Chinese (or English or Both), user would select pronunciation icon 110, which would cause pronunciation system to access the language dictionary and pronounce the term “Quick.” If user 24 wished to reference text that was previously converted, user 24 would selected reference icon 112. This would cause reference system 37 to access database 22 and present user 24 with a list of previously converted text. Icons 114 for other features for manipulating selected text 100 could also be included. One example of such a feature is a thesaurus feature for determining English and/or Chinese equivalents of selected text 100. In this event, language dictionaries 42 should also include thesaurus capabilities.

It should be understood that although selected text 100 is shown in FIG. 3 as being only one term, user 24 could select a group of words for conversion. Moreover, it should be understood that conversion system 26 should be able to convert selected text both from a source language to a destination language and from a destination language to the source language. In addition, text 102 shown on display can be “boiler-plate” text stored in an accessed language dictionary 42, or can be text inputted by user 24. In either event, the present invention provides conversion of selected text 100 between designated languages.

It is understood that the present invention can be realized in hardware, software, or a combination of hardware and software. Moreover, computer system 10 according to the present invention can be realized in a centralized fashion in a single computerized workstation, or in a distributed fashion where different elements are spread across several interconnected systems (e.g., a network). Any kind of computer/server system(s)—or other apparatus adapted for carrying out the methods described herein— is suited. A typical combination of hardware and software could be a general purpose computer system with a computer program that, when loaded and executed, controls computer system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which— when loaded in a computer system— is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A computerized system for converting selected text between languages, comprising:
a language system for designating a source language and a destination language;
a dictionary system for accessing a language dictionary corresponding to the designated source language and destination language; and
a translation system for translating selected text between the source language and the destination language based upon the language dictionary.

2. The system of claim 1, further comprising an update system for updating the language dictionary based on an update schedule.

3. The system of claim 1, further comprising a pronunciation system for pronouncing the selected text based upon the language dictionary.

4. The system of claim 3, wherein the selected text is pronounced in the destination language.

5. The system of claim 1, further comprising a key system for designating a keystroke for selecting displayed text.

6. The system of claim 1, wherein the language dictionary is downloaded from a remote source and is stored locally.

7. The system of claim 1, further comprising a reference system for referencing previously selected text.

8. The system of claim 1, wherein the selected text is translated from the source language to the destination language.

9. A computerized system for converting selected text between languages, comprising:
a language system for designating a source language and a destination language;
a dictionary system for retrieving a language dictionary corresponding to the designated source language and destination language from a remote source;
a key system for designating a keystroke for selecting displayed text;
a translation system for translating the selected text from the source language to the destination language based upon the language dictionary;
a pronunciation system for pronouncing the selected text in the destination language based upon the language dictionary; and
an update system for updating the retrieved language dictionary.

10. The system of claim 9, further comprising a reference system for referencing previously selected text.

11. The system of claim 9, wherein the update system updates the language dictionary based on a designated language schedule.

12. A computerized method for converting selected text between languages, comprising:
providing an interface for designating a source language and a destination language;
accessing a language dictionary corresponding to the designated source language and destination language;
selecting displayed text using a predefined keystroke; and
translating the selected text between the source language and the destination language based on the language dictionary.

13. The method of claim 12, further comprising the step of providing an interface for designating a keystroke for selecting displayed text, prior to the selecting step.

14. The method of claim 12, wherein the accessing step comprises downloading a language dictionary corresponding to the designated source language and destination language from a remote source.

15. The method of claim 12, wherein the translating step comprises translating the selected text from the source language to the destination language based on the language dictionary.

16. The method of claim 12, further comprising pronouncing the selected text in the destination language based on the translation dictionary.

17. The method of claim 12, further comprising referencing previously selected text.

18. The method of claim 12, further comprising updating the language dictionary.

19. The method of claim 18, further comprising providing an interface for designating an update schedule for updating the language dictionary.

20. A program product stored on a recordable medium for converting selected text between languages, which when executed, comprises:
program code for designating a source language and a destination language;
program code for accessing a language dictionary corresponding to the designated source language and destination language; and
program code for translating selected text between the source language and the destination language.

21. The program product of claim 20, further comprising a pronunciation system for pronouncing the selected text based upon the language dictionary.

22. The program product of claim 20, further comprising a key system for designating a keystroke for selecting displayed text.

23. The program product of claim 20, wherein the language dictionary is downloaded from a remote source.

24. The program product of claim 20, further comprising a reference system for referencing previously selected text.

25. The program product of claim 20, further comprising program code for updating the language dictionary.

26. The program product of claim 25, further comprising program code for designating an update schedule for updating the language dictionary.
